(19) United States
(12) Patent Application Publication
(10) Pub. No.: US 2020/0294019 A1
(43) Pub. Date: Sep. 17, 2020

(54) SETTLEMENT DEVICE AND CONTROL METHOD THEREOF

(71) Applicant: TOSHIBA TEC KABUSHIKI KAISHA, Tokyo (JP)

(72) Inventor: Yoshitaka IWAZAKI, Sunto Shizuoka (JP)

(73) Assignee: TOSHIBA TEC KABUSHIKI KAISHA, Tokyo (JP)

(21) Appl. No.: 16/714,006

(22) Filed: Dec. 13, 2019

(30) Foreign Application Priority Data
Mar. 15, 2019 (JP) 2019-048308

(51) Int. Cl. G06Q 20/20; G06Q 20/06; G06Q 20/40; G06Q 20/36; G06Q 20/34; G06Q 20/18

(52) U.S. Cl. CPC G06Q 20/204; G06Q 20/065; G06Q 20/18; G06Q 20/3678; G06Q 20/341; G06Q 20/403

(57) ABSTRACT

A settlement device can acquire a payment amount and a balance of electronic money. When the balance is less than the payment amount, the settlement device gives a notification of a necessary charging amount set based on an amount of money obtained by subtracting the balance from the payment amount. The settlement device receives an input of money. When the necessary charging amount is notified and an input of money equal to or greater than the necessary charging amount is received, the settlement device settles a transaction by updating the balance to the amount of money obtained by subtracting the payment amount from the amount of money obtained by adding the input amount of money to the balance.

### CROSS-REFERENCE TO RELATED APPLICATION

This application is based upon and claims the benefit of priority from Japanese Patent Application No. 2019-048308, filed in Mar. 15, 2019, the entire contents of which are incorporated herein by reference.

### FIELD

Embodiments described herein relate generally to a settlement device and a control method for a computer as the settlement device.

### BACKGROUND

In recent years, electronic settlement services in which IC cards, smartphones, and the like are used as media have become widespread. Electronic settlement services are services in which prices for commodities or prices for labor are paid by moving electronic money values. The electronic money values are generally called electronic money. As such electronic settlement services are widespread, settlement devices corresponding to the electronic settlement services are introduced in many stores.

In electronic settlement services, there are advance payment systems (prepaid systems) and deferred payment systems (postpaid systems). In the case of the prepaid systems, users of the electronic settlement services are required to deposit electronic money in advance. Depositing electronic money is generally referred to as charging. Some settlement devices corresponding to electronic settlement services have functions of charging electronic money. When users charge electronic money using the charging functions of the settlement devices, the users are required to charge electronic money until the electronic money reaches at least an amount of money necessary for payment.

### DESCRIPTION OF THE DRAWINGS

FIG. 1 is a schematic diagram illustrating a checkout system according to an embodiment;

FIG. 2 is a block diagram illustrating a circuit configuration of main units of a registration device that forms a part of the checkout system;

FIG. 3 is a block diagram illustrating a circuit configuration of main units of a settlement device that forms a part of the checkout system;

FIG. 4 is a flowchart illustrating a procedure of a main information process performed by a processor of the settlement device according to a settlement program;

FIG. 5 is a flowchart illustrating the procedure of the main information process performed by the processor of the settlement device according to the settlement program;

FIG. 6 is a flowchart illustrating the procedure of the main information process performed by the processor of the settlement device according to the settlement program;

FIG. 7 is a flowchart illustrating the procedure of the main information process performed by the processor of the settlement device according to the settlement program;

FIG. 8 is a flowchart illustrating the procedure of the main information process performed by the processor of the settlement device according to the settlement program;

FIG. 9 is a diagram illustrating an example of a payment method selection screen displayed on a touch panel of the settlement device;

FIG. 10 is a diagram illustrating an example of a reading standby screen displayed on the touch panel of the settlement device;

FIG. 11 is a diagram illustrating an example of a payment completion selection screen displayed on the touch panel of the settlement device;

FIG. 12 is a diagram illustrating an example of a charging screen displayed on the touch panel of the settlement device before a charging amount of money is designated;

FIG. 13 is a diagram illustrating an example of a charging screen displayed on the touch panel of the settlement device after the charging amount of money is designated; and

FIG. 14 is a diagram illustrating an example of a cash input screen displayed on the touch panel of the settlement device.

### DETAILED DESCRIPTION

Embodiments provide a settlement device capable of easily ascertaining a charging amount of money necessary for payments by a user of electronic money.

In general, according to some embodiments, a settlement device of a point of sales terminal includes payment amount acquisition means, balance acquisition means, first settlement means, first notification means, input means, and second settlement means. The payment amount acquisition means acquires a payment amount. The balance acquisition means acquires a balance of electronic money. The first settlement means settles a transaction by updating the balance to an amount of money obtained by subtracting the payment amount from the balance when the balance is equal to or greater than the payment amount. The first notification means gives a notification of a necessary charging amount set based on an amount of money obtained by subtracting the balance from the payment amount when the balance is less than the payment amount. The input means (or money input device) receives an input of money. The second settlement means settles a transaction by updating the balance to an amount of money obtained by subtracting the payment amount from the amount of money obtained by adding the input amount of money to the balance when the first notification means gives the notification of the necessary charging amount and the input means receives the input of money equal to or greater than the necessary charging amount.

Hereinafter, an exemplary embodiment of a settlement device capable of easily ascertaining a charging amount of money necessary for payments by a user of electronic money will be described with reference to the drawings.

According to some embodiments, a semi-self-service-type checkout system introduced in a retail store such as a mass retailer will be exemplified. The semi-self-service-type checkout system includes a registration device that registers sales data of commodities purchased by a customer and generates accounting data and a settlement device that settles a transaction according to a payment method such as cash, electronic money, or a credit card based on the accounting data generated by the registration device. The registration device and the settlement device are separately installed. In the operation system, a salesclerk operates the registration device, and the customer operates the settlement device. The function of the settlement device is to charge electronic money.

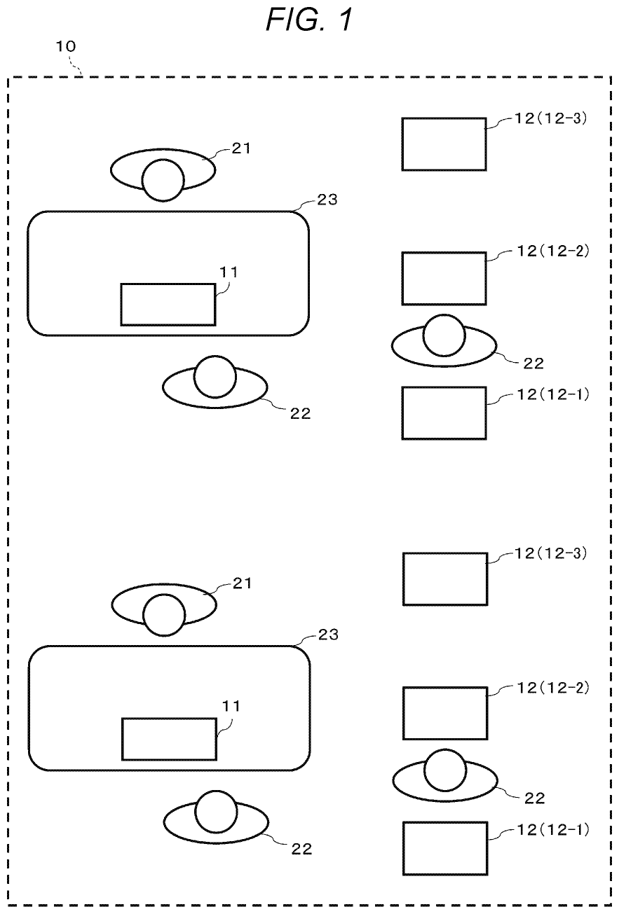

FIG. 1 is a schematic diagram illustrating a checkout system 10 according to an embodiment. The checkout system 10 includes a plurality of registration devices 11 and a plurality of settlement devices 12. The registration device 11 and the settlement device 12 are disposed for each checkout lane of a store. FIG. 1 illustrates an exemplary embodiment in which the number of settlement devices 12 is greater than the number of registration devices 11. However, it will be appreciated that the number of settlement devices 12 connected to the registration devices 11 are not limited to the embodiments described herein.

FIG. 1 illustrates a case in which two registration devices 11 and six settlement devices 12 are disposed in two checkout lanes. In FIG. 1, one registration device 11 and three settlement devices 12 (12-1, 12-2, and 12-3) are disposed in one checkout lane. The checkout system 10 includes any number of registration devices 11 and any number of settlement devices 12. A ratio of the number of registration devices 11 to the number of settlement devices 12 disposed in the checkout lane is optional.

For the registration device 11, a salesclerk 21, for example, a cashier, is an operator. For the settlement device 12, a customer 22 who purchases a commodity sold in the store is an operator. That is, the checkout system 10 is a semi-self-service-type system.

The registration device 11 is mounted on a working table 23 in FIG. 1. The working table 23 has a rectangular tabletop. By disposing a plurality of the working tables 23 so that the longitudinal directions of the tabletop are substantially parallel, a passage for the customer 22, or checkout lane is formed.

The registration device 11 has functions of registering sales commodities, generating accounting data, and transmitting the accounting data to the settlement device 12. As registration of sales commodities, commodities purchased by the customer 22 are registered as sales commodities in the registration device 11. For example, by reading barcodes attached to the commodities with a scanner, the commodities are registered as sales commodities in the registration device 11. The accounting data is data related to accounting of the sales commodities registered as one transaction and is used for a settlement process to be described below. The accounting data includes commodity codes, which are identification codes of the sales commodities, commodity names, unit prices, and the number of sales commodities, and a payment amount calculated from the unit price and the number of sales commodities.

The settlement device 12 has functions of receiving the accounting data and transmitting the accounting data to another settlement device 12, and a function of a settlement process. The settlement process refers to a process of settling transactions that are commodity selling and buying actions based on the accounting data. In the settlement, cash, a credit card, electronic money, or the like is used as a payment method for the price. When accounting data is received from the registration device 11 or another settlement device 12, the settlement device 12 performs a transaction settlement process based on the accounting data.

In the payment, a cash voucher such as a gift certificate can be used as a payment method for the price in some cases. At the time of settlement by a cash voucher, a salesclerk is required to verify a cash voucher. Therefore, the registration device 11 also has a function of a settlement process and is designed to mainly perform the settlement process by a note. The registration device 11 is designed to be able to perform the settlement process by cash, a credit card, electronic money, or the like independently of the settlement device 12.

Although not illustrated, the registration devices 11 and the settlement devices 12 are all connected to a local area network (LAN). A server is connected to the LAN. The server has a commodity database in which commodity information such as a commodity name or a unit price is set in association with the commodity code of each commodity. The registration device 11 and the settlement device 12 or a pair of settlement devices 12 can transmit and receive information via the LAN. The registration device and the settlement device may be configured to transmit and receive information via the server. Instead of the LAN, another communication network such as the Internet or a wireless LAN may be used as the network.

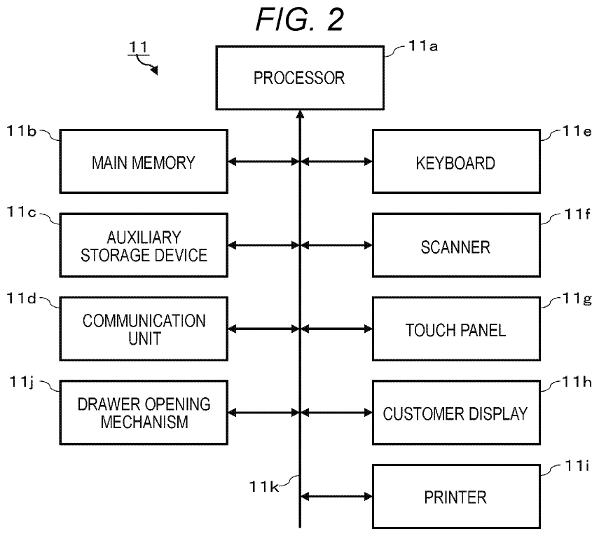

FIG. 2 is a block diagram illustrating a circuit configuration of main units of the registration device 11. The registration device 11 includes a processor 11a, a main memory 11b, an auxiliary storage device 11c, a communication unit 11d, a keyboard 11e, a scanner 11f, a touch panel 11g, a customer display 11h, a printer 11i, a drawer opening mechanism 11j, and a system transmission path 11k. The system transmission path 11k includes an address bus, a data bus, and a control signal line. The system transmission path 11k connects the processor 11a to the main memory 11b, the auxiliary storage device 11c, the communication unit 11d, the keyboard 11e, the scanner 11f, the touch panel 11g, the customer display 11h, the printer 11i, and the drawer opening mechanism 11j. The processor 11a, the main memory 11b, and the auxiliary storage device 11c are connected by the system transmission path 11k to configure a computer of the registration device 11.

The processor 11a is equivalent to a central part of the computer. The processor 11a controls each unit such that various functions can be realized as the registration device 11 according to an operating system or an application program. The processor 11a is, for example, a central processing unit (CPU).

The main memory 11b is equivalent to a main storage unit of the computer. The main memory 11b includes a nonvolatile memory region and a volatile memory region. The main memory 11b stores an operating system or an application program in the nonvolatile memory region. The main memory 11b stores data necessary for the processor 11a to perform a process of controlling each unit in a nonvolatile or volatile memory region in some cases. The main memory 11b uses the volatile memory region as a work area in which data can be appropriately rewritten by the processor 11a. In accordance with some embodiments, the nonvolatile memory region may be a read-only memory (ROM) and the volatile memory region may be a random access memory (RAM).

The auxiliary storage device 11c is equivalent to an auxiliary storage unit of the computer. For example, an electric erasable programmable read-only memory (EEPROM), a hard disk drive (HDD), a solid-state drive (SSD), or the like can serve as the auxiliary storage device 11c. The auxiliary storage device 11c stores data used by the processor 11a to perform various processes, data generated through a process in the processor 11a, and the like. The auxiliary storage device 11c stores the application program in some cases.

The application program stored in the main memory 11b or the auxiliary storage device 11c includes a registration program in which information processing to be performed by the registration device 11 is described. A method of installing the registration program in the main memory 11b or the auxiliary storage device 11c is not particularly limited. By recording the registration program on a removable recording medium or delivering the registration program through communication via a network, the registration program can be installed in the main memory 11b or the auxiliary storage device 11c. Any form of the recording medium can be used as long as a recording medium such as a CD-ROM or a memory card can store a program and can be read by a device.

The communication unit 11d performs data communication with the settlement device 12 connected via the LAN. The communication unit 11d can perform data communication with another registration device 11 and the server connected via the LAN.

The keyboard 11e is a keyboard dedicated for the registration device in which known keys such as ten keys, a subtotal key, a cancel key, and a clear key are disposed. For the keyboard 11e, functions of the subtotal key, the cancel key, and the clear key may be allocated to a general-purpose keyboard with the ten keys.

The scanner 11f reads a code symbol such as a barcode or a 2-dimensional data code. The scanner 11f may be a type of scanner that reads a code symbol by radiating laser light or may be a type of scanner that reads a code symbol from an image captured by an imaging device.

The touch panel 11g is a device that serves as both an input device and a display device. The touch panel 11g displays information for a salesclerk who is an operator of the registration device 11 and receives an operation input by the salesclerk.

The customer display 11h displays information for a customer who is registering commodities to be purchased in the registration device 11.

The printer 11i issues a receipt by printing various text strings, images, or the like on a receipt sheet. Printer 11i, for example, may be a thermal printer or a dot impact printer.

The drawer opening mechanism 11j opens a drawer in which cash or cash voucher such as gift certificates and coupons are accommodated.

As hardware of the registration device 11, for example, a known point of sales (POS) terminal can be used.

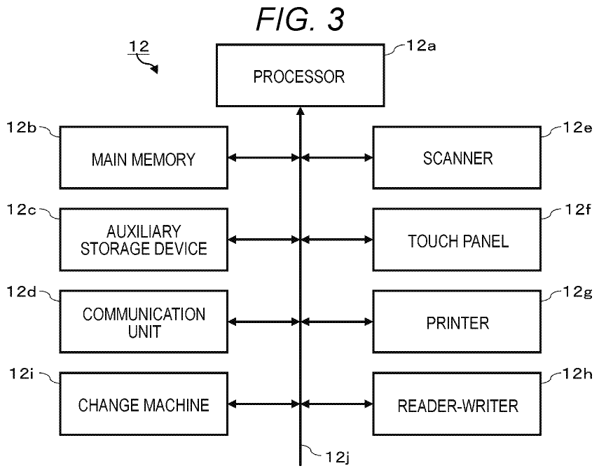

FIG. 3 is a block diagram illustrating a circuit configuration of main units of the settlement device 12. The settlement device 12 includes a processor 12a, a main memory 12b, an auxiliary storage device 12c, a communication unit 12d, a scanner 12e, a touch panel 12f, a printer 12g, a reader-writer 12h, a change machine 12i, and a system transmission path 12j. The system transmission path 12j includes an address bus, a data bus, and a control signal line. The system transmission path 12j connects the processor 12a to the main memory 12b, the auxiliary storage device 12c, the communication unit 12d, the scanner 12e, the touch panel 12f, the printer 12g, the reader-writer 12h, and the change machine 12i. The processor 12a, the main memory 12b, and the auxiliary storage device 12c are connected by the system transmission path 12j to configure a computer of the settlement device 12.

The processor 12a is equivalent to a central part of the computer. The processor 12a controls each unit such that various functions can be realized as the settlement device 12 according to an operating system or an application program. The processor 12a is, for example, a CPU.

The main memory 12b is equivalent to a main storage unit of the computer. The main memory 12b includes a nonvolatile memory region and a volatile memory region. The main memory 12b stores an operating system or an application program in the nonvolatile memory region. The main memory 12b stores data necessary for the processor 12a to perform a process of controlling each unit in a nonvolatile or volatile memory region in some cases. The main memory 12b uses a volatile memory region as a work area in which data can be appropriately rewritten by the processor 12a. The nonvolatile memory region is, for example, a ROM. The volatile memory region is, for example, a RAM.

The auxiliary storage device 12c is equivalent to an auxiliary storage unit of the computer. For example, an EEPROM, a HDD, an SSD, or the like can serve as the auxiliary storage device 12c. The auxiliary storage device 12c stores data used for the processor 12a to perform various processes, data generated through a process in the processor 12a, and the like. The auxiliary storage device 12c stores the application program in some cases.

The application program stored in the main memory 12b or the auxiliary storage device 12c includes a control program, which is a so-called settlement program, in which information processing to be performed by the settlement device 12 is described. A method of installing the settlement program in the main memory 12b or the auxiliary storage device 12c is not particularly limited. By recording the settlement program on a removable recording medium or delivering the settlement program through communication via a network, the settlement program can be installed in the main memory 12b or the auxiliary storage device 12c. As long as a recording medium such as a CD-ROM or a memory card can store a program and can be read by a device, any form of the recording medium can be used.

The communication unit 12d performs data communication with the registration device 11 connected via the LAN. The communication unit 12d can perform data communication with another settlement device 12 and the server connected via the LAN.

The scanner 12e reads a code symbol such as a barcode or a 2-dimensional data code. The scanner 12e may be a type of scanner that reads a code symbol by radiating laser light or may be a type of scanner that reads a code symbol from an image captured by an imaging device.

The touch panel 12f is a device that serves as both an input device and a display device. The touch panel 12f displays information for a customer who is an operator of the settlement device 12 and receives an operation input by the customer.

The printer 12g issues a receipt by printing various text strings, images, or the like on a receipt sheet. Printer 12g can be a thermal printer or a dot impact printer.

The reader-writer 12h has a function of reading data recorded on a medium such as a card or a smartphone and a function of writing data on the medium. Examples of the card include not only cards for settlement, such as a credit card, a debit card, an electronic money card, and a prepaid card but also membership cards called member's cards or point cards. The reader-writer 12h may be any of magnetic, contact, or contactless devices or may include a plurality of types of devices.

The change machine 12i takes input coins and bills. The change machine 12i discharges coins and bills as change.

As hardware of the settlement device 12, for example, a POS terminal, which is a so-called self-register, corresponding to a known self-service-type checkout system can be used.

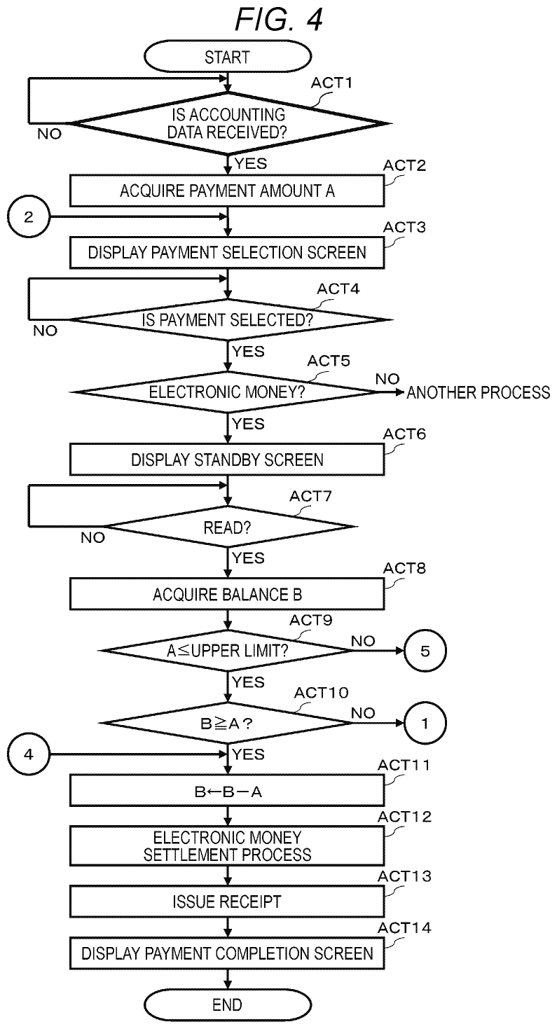

The settlement device 12 with the configuration has a charging function capable of charging electronic money when a price is paid with electronic money. The charging function will be described specifically with reference to FIGS. 4 to 14.

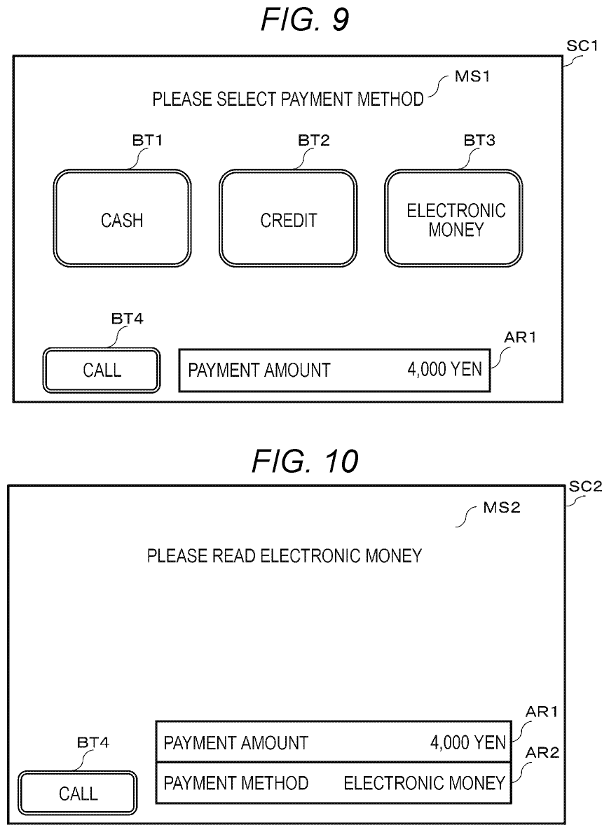

FIGS. 4 to 8 are flowcharts illustrating a procedure of a main information process performed by the processor 12a of the settlement device 12 according to a settlement program. FIGS. 9 to 14 are diagrams illustrating various screen examples displayed on the touch panel 12f in response to the information processing. The procedure of the information processing and content of screen display are not limited thereto. Various modifications of the procedure of the information processing and the content of the screen display can be made as long as the same results can be obtained.

The processor 12a waits for reception of accounting data in ACT1. As described above, the registration device 11 generates the accounting data. Then, the accounting data generated by the registration device 11 is transmitted to the settlement device 12 in the same checkout lane. The accounting data is transmitted from another settlement device in the same checkout lane in some cases. The accounting data is transmitted from the registration device 11 or the settlement device 12 in another checkout lane in some cases.

When the accounting data is received via the communication unit 12d, the processor 12a determines YES in ACT1, and the process proceeds to ACT2. The processor 12a stores the accounting data received in ACT2 in the main memory 12b and acquires a payment amount A, which is the price from the accounting data. The payment amount A is an amount calculated as an amount of money that the customer 22 has to pay based on sales data of commodities registered as one transaction in the registration device 11. The accounting data includes data of the payment amount A.

The processor 12a acquiring the payment amount A and storing the payment amount A in the main memory 12b switches a screen of the touch panel 12f from an initial screen to a payment method selection screen SC1 (see FIG. 9) in ACT3. Any initial screen can be used. For example, the initial screen may be a screen on which a message such as “Welcome” is displayed. Alternatively, the initial screen may be a screen on which the payment method selection screen SC1 is displayed in an inactive state.

FIG. 9 illustrates one display example of the payment method selection screen SC1. As illustrated in FIG. 9, a message MS1 prompting to select a payment method is displayed on the payment method selection screen SC1. Images of a cash button BT1, a credit button BT2, an electronic money button BT3, and a call button BT4 and a payment amount area AR1 are disposed on the payment method selection screen SC1.

The cash button BT1 is a button image for receiving an announcement of cash payment. The credit button BT2 is a button image for receiving an announcement of credit card payment. The electronic money button BT3 is a button image for receiving an announcement of electronic money payment. The call button BT4 is a button image for calling a salesclerk. The payment amount area AR1 is an area for displaying the payment amount A stored in ACT2. According to the payment method selection screen SC1 in FIG. 9, the payment amount A is 4,000 yen.

In the embodiment, three kinds of payment methods can be used in the settlement device 12, including cash, a credit card, and electronic money, but it will be appreciated that the payment method is not limited thereto. For example, a payment method using cumulative points of service (i.e., in-store credit) may be included. A credit card transaction may be divided into a credit card of a store-associated company and credit cards of other companies. Similarly, electronic money may be divided into electronic money of the store-associated company and electronic money of other companies.

The customer 22 moving to the settlement device 12 to which accounting data of sales commodities registered in the registration device 11 is transmitted, selects a payment method from the payment method selection screen SC1. For example, the customer 22 who desires to use the cash payment touches the cash button BT1. Then, the customer 22 inputs cash equal to or greater than a payment amount to the change machine 12i. The customer 22 who desires to use the credit card payment touches the credit button BT2. Then, the customer 22 allows the reader-writer 12h to read a credit card. The customer 22 who desires to use the electronic money payment touches the electronic money button BT3. Then, the customer 22 allows the reader-writer 12h to read data from a medium related to the electronic money. The medium related to the electronic money (the electronic money medium) for example, may be an IC card or a smartphone.

The processor 12a controlling the display of the payment method selection screen SC1 waits for selection of the payment method in ACT4. Specifically, the processor 12a waits for a touch of the cash button BT1, a touch of the credit button BT2, or a touch of the electronic money button BT3. Incidentally, when the processor 12a detects that the call button BT4 is touched in the waiting state, the processor 12a controls the communication unit 12d such that a call command is transmitted to the registration device 11. Through this control, the call command destined for the registration device 11 is transmitted from the communication unit 12d. The processor 11a of the registration device 11 receiving the call command via the communication unit 11d displays, on the touch panel 11g, a notification to a salesclerk that the call of the salesclerk has been received.

When the processor 12a detects that the cash button BT1, the credit button BT2, or the electronic money button BT3 is touched in the waiting state of ACT4, the processor 12a determines YES and the process proceeds to ACT5. The processor 12a determines whether the button touched in ACT5 is the electronic money button BT3. When the touched button is not the electronic money button BT3, the processor 12a determines NO in ACT5 and performs another process. For example, when the touched button is the cash button BT1, the processor 12a performs a settlement process by cash payment. When the touched button is the credit button BT2, the processor 12a performs a settlement process by credit card payment. Since the settlement processes are existing processes and are known, description thereof will not be repeated.

When the touched button is the electronic money button BT3, the processor 12a determines YES in ACT5 and the process proceeds to ACT6. The processor 12a switches the screen of the touch panel 12f from the payment method selection screen SC1 to a reading standby screen SC2 (see FIG. 10) of electronic money in ACT6.

FIG. 10 illustrates one display example of the reading standby screen SC2. As illustrated in FIG. 10, a message MS2 prompting to read electronic money is displayed on the reading standby screen SC2. An image of a call button BT4, a payment amount area AR1, and a payment method area AR2 are disposed on the reading standby screen SC2. Although not illustrated, an illustration indicating an operation of reading electronic money is also displayed in part of the reading standby screen SC2. The payment method area AR2 is an area for displaying the payment method selected in ACT4. The customer 22 checking the reading standby screen SC2, that is, a user of electronic money, allows the reader-writer 12h to read data of a medium related to the electronic money. Incidentally, the reading standby screen SC2 in FIG. 10 exemplifies selection of the electronic money as the payment method for a transaction in which the payment amount A is 4,000 yen.

The processor 12a controlling the display of the reading standby screen SC2 waits for reading of data by the reader-writer 12h in ACT7. When the data of the electronic money medium is input via the reader-writer 12h in the waiting state, the processor 12a determines YES in ACT7 and the process proceeds to ACT8. The processor 12a stores the data of the electronic money medium read in ACT8 in the main memory 12b and acquires a balance B of the electronic money based on the data. The balance B is included in the data read from the electronic money medium. The balance B may be stored in a server on a network in association with the data read from the electronic money medium. In this case, the processor 12a acquires the balance B from the server.

In ACT9, the processor 12a acquiring the balance B and storing the balance B in the main memory 12b checks whether the payment amount A is equal to or less than a balance upper limit of the electronic money. The balance upper limit is a maximum balance amount of the electronic money associated with the electronic money medium. The electronic money may not be charged over the balance upper limit.

When the payment amount A is equal to or less than the balance upper limit, the processor 12a determines YES in ACT9 and the process proceeds to ACT10. In ACT10, the processor 12a checks whether the balance B is equal to or greater than the payment amount A. When the balance B is equal to or greater than the payment amount A, the payment amount A can be paid with electronic money. That is, settlement of the electronic money is established.

When the balance B is equal to or greater than the payment amount A, the processor 12a determines YES in ACT10 and the process proceeds to ACT11. In ACT11, the processor 12a updates the balance B stored in the main memory 12b to a value obtained by subtracting the payment amount A from the balance B. Then, the processor 12a performs a settlement process for the electronic money in ACT12. Since the settlement process is an existing process and is known, specific description thereof will not be repeated. In the settlement process, when the balance B is included in the data read from the electronic money medium, the balance B can be rewritten to an amount of money after the payment amount A is subtracted. When the balance B is stored in the server, the balance B is updated to the amount of money after the payment amount A is subtracted.

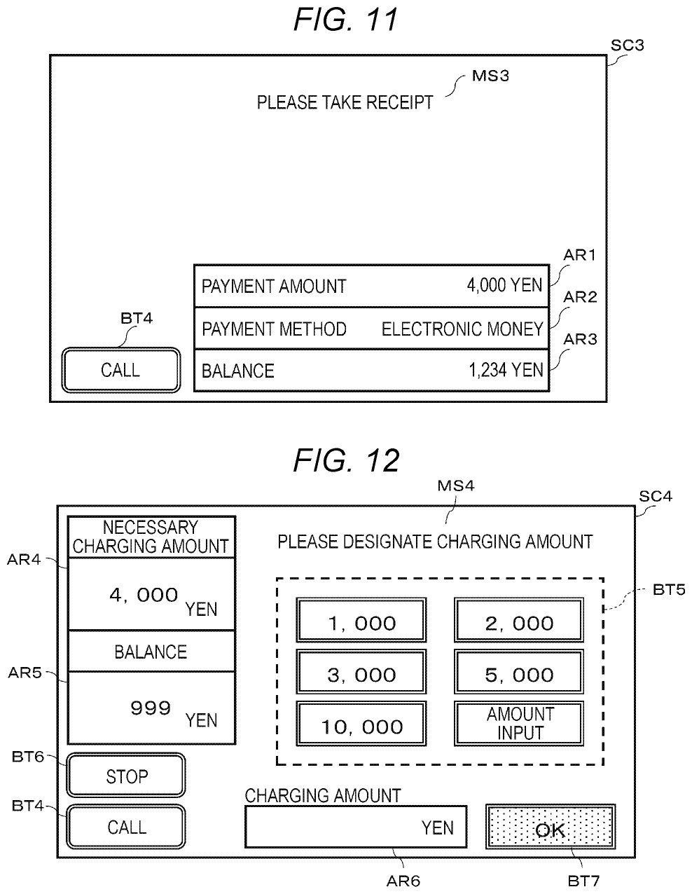

When the settlement process ends, the processor 12a controls issuing of a receipt in ACT13. That is, the processor 12a generates receipt data including detailed information regarding commodities registered as one transaction and payment information indicating that the payment amount of the transaction is paid with the electronic money based on the accounting data and outputs the receipt data to the printer 12g. Through this control, the printer 12g operates to print the receipt data on a sheet. Then, the printing ends, the sheet is cut, and issued as a receipt. When the receipt is issued, the processor 12a switches the screen of the touch panel 12f from the reading standby screen SC2 to a payment completion screen SC3 (see FIG. 11) in ACT14.

FIG. 11 illustrates one display example of the payment completion screen SC3. As illustrated in FIG. 11, a message MS3 for warning against forgetting a receipt is displayed on the payment completion screen SC3. An image of a call button BT4, a payment amount area AR1, a payment method area AR2, and a balance area AR3 are disposed on the payment completion screen SC3. Although not illustrated, an illustration indicating an issuance port of a receipt is also displayed in a part of the payment completion screen SC3. The balance area AR3 is an area for displaying a balance of electronic money after the payment amount A is subtracted. Incidentally, the payment completion screen SC3 in FIG. 11 exemplifies reading of electronic money of 5,234 yen as the balance B after the reading standby screen SC2 in FIG. 10 is displayed. That is, the payment completion screen SC3 exemplifies updating of the balance B of the electronic money to an amount of money of 1,234 yen obtained by subtracting a payment amount of 4,000 yen from the original balance of 5,234 yen.

A user checking the payment completion screen SC3 moves away from the settlement device 12 after the user receives a receipt. When the user moves away from the settlement device 12, the screen of the touch panel 12f returns to the initial screen. In this way, the processor 12a ends the information processing when the balance B of the electronic money is equal to or less than a balance upper limit and equal to or greater than the payment amount A.

Next, a case in which the balance B of the electronic money is less than the payment amount A will be described.

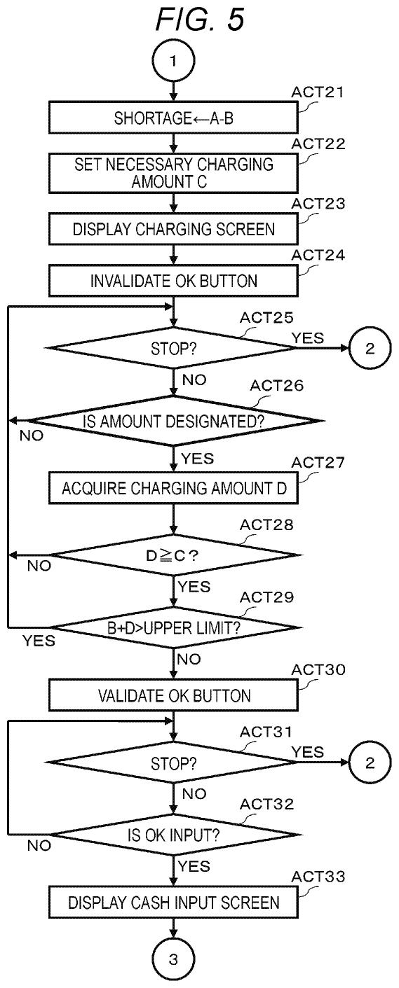

When the balance B of the electronic money is less than the payment amount A, the processor 12a determines NO in ACT10 and the process proceeds to ACT21 of FIG. 5. The processor 12a calculates a shortage of the balance B with respect to the payment amount A in ACT21. That is, the processor 12a calculates an amount of money obtained by subtracting the balance B from the payment amount A as the shortage.

When the shortage is calculated, the processor 12a sets a necessary charging amount C based on the shortage in ACT22. In the embodiment, a unit of a charging amount is a thousand yen. The processor 12a sets an amount of money obtained by rounding up the shortage in a unit equal to or less than a hundred yen as the necessary charging amount C. For example, when the payment amount A is 4,000 yen and the balance B of the electronic money is 1,001 yen, a shortage is 2,999 yen. Therefore, the necessary charging amount C is 3,000 yen. For example, when the payment amount A is 4,000 yen and the balance B of the electronic money is 999 yen, a shortage is 3,001 yen. Therefore, the necessary charging amount C is 4,000 yen.

The processor 12a setting the necessary charging amount C switches the screen of the touch panel 12f from the reading standby screen SC2 to a charging screen SC4 (see FIG. 12) in ACT23.

FIG. 12 illustrates one display example of the charging screen SC4. As illustrated in FIG. 12, a message MS4 prompting to designate a charging amount is displayed on the charging screen SC4. An image of a charging button BT5, an image of a call button BT4, an image of a stop button BT6, an image of an OK button BT7, a necessary charging amount area AR4, a balance area AR5, and a charging amount area AR6 are disposed on the charging screen SC4.

The charging button BT5 includes five amount buttons (e.g., a designation device) corresponding to charging amounts of money of 1,000 yen, 2,000 yen, 3,000 yen, 5,000 yen, and 10,000 yen, and an amount input button. The amount buttons are buttons for designating the allocated charging amounts. The amount input buttons are buttons for designating any charging amount in units of 1,000 yen. When the amount input button is touched, an image of a ten key button is displayed on the touch panel 12f to overlap the charging screen SC4. For example, when 4,000 yen is designated as a charging amount, the user touches a ten key button of “4.” The settlement device then designates the charging amount to be 4,000 yen. Similarly, for example, when the user touches ten key buttons of “1” and “5” in this order, the settlement device 12 designates the charging amount to be 15,000 yen. An amount of money of which a balance after charging exceeds a balance upper limit may not be designated as a charging amount.

The stop button BT6 is a button for giving an instruction to stop charging. The OK button BT7 is a button image for giving an instruction to confirm a charging amount. The necessary charging amount area AR4 is an area for displaying the necessary charging amount C set in ACT22. The balance area AR5 is an area for displaying the balance B of electronic money stored in ACT8. The charging amount area AR6 is an area for displaying the designated charging amount. Before the charging amount is designated, the charging amount area AR6 is blank. Alternatively, 0 yen may be displayed in the charging amount area AR6. In addition, the payment amount area AR1 may be disposed in the charging screen SC4 and the user may be able to check the payment amount A. FIG. 12 illustrates the balance B of electronic money as 999 yen in addition to the payment amount A of 4,000 yen.

The processor 12a displaying the charging screen SC4 invalidates the OK button BT7 in ACT24. Specifically, even when the OK button BT7 of the charging screen SC4 is touched, the processor 12a enters a state in which the input is not received. As illustrated in FIG. 12, the processor 12a grays out the image of the OK button BT7 to indicate that the OK button BT7 is inactive.

The user checking the charging screen SC4 operates the charging button BT5 to designate a charging amount equal to or greater than the necessary charging amount C. However, for example, when the user does not have cash equal to or greater than the necessary charging amount C, the user touches the stop button BT6 to give an instruction to stop the charging.

The processor 12a invalidating the OK button BT7 checks in ACT25 whether the stop button BT6 is input. When the stop button BT6 is not input, the processor 12a determines NO in ACT25 and the process proceeds to ACT26. In ACT26, the processor 12a checks whether the charging amount is designated. When the charging amount is not designated, the processor 12a determines NO in ACT26 and the process returns to ACT25. Here, the processor 12a waits for an input of the stop button BT6 or designation of the charging amount input in ACT25 and ACT26.

When the processor 12a detects that the stop button BT6 is touched with a signal from the touch panel 12f in the waiting state of ACT25 and ACT26, the processor 12a determines YES in ACT25 and the process returns to ACT3 of FIG. 4. That is, the processor 12a returns the screen of the touch panel 12f from the charging screen SC4 to the payment method selection screen SC1. Then, the processor 12a waits for selection of any payment method.

When the processor 12a detects that the charging amount is designated with the signal from the touch panel 12f in the waiting state of ACT25 and ACT26, the processor 12a determines YES in ACT26 and the process proceeds to ACT27. The processor 12a acquires a charging amount D in ACT27. For example, when the amount button of 1,000 yen inside the charging button BT5 is touched, the processor 12a acquires 1,000 yen as the charging amount D. The same applies when the amount button of 2,000 yen, the amount button of 3,000 yen, the amount button of 5,000 yen, or the amount button of 10,000 yen is touched. Conversely, when the amount input button is touched, the processor 12a acquires the amount of money designated through a subsequent touch operation on the ten key button as the charging amount D.

The processor 12a acquiring the charging amount D and storing the charging amount D in the main memory 12b compares the charging amount D with the necessary charging amount C in ACT28. Then, the processor 12a checks whether the charging amount D is equal to or greater than the necessary charging amount C. When the charging amount D is less than the necessary charging amount C, the processor 12a determines NO in ACT28 and the process returns to ACT25. That is, the processor 12a discards the charging amount D acquired in ACT27 and the process returns to the waiting state of ACT25 and ACT26.

When the charging amount D is equal to or greater than the necessary charging amount C, the processor 12a determines YES in ACT28 and the process proceeds to ACT29. In ACT29, the processor 12a checks whether an amount of money obtained by adding the charging amount D to the balance B of the electronic money exceeds the balance upper limit. When the amount of money obtained by adding the charging amount D to the balance B exceeds the balance upper limit, the processor 12a determines NO in ACT29 and the process returns to ACT25. That is, the processor 12a discards the charging amount D acquired in ACT27 and the process returns to the waiting state of ACT25 and ACT26.

When the amount of money obtained by adding the charging amount D to the balance B is equal to or less than the balance upper limit, the processor 12a determines YES in ACT29 and the process proceeds to ACT30. The processor 12a validates the OK button BT7 of the charging screen SC4 in ACT30. Specifically, when the OK button BT7 of the charging screen SC4 is touched, the processor 12a enters an input reception state. Then, the processor 12a activates the image of the OK button BT7. The processor 12a displays the charging amount D in the charging amount area AR6.

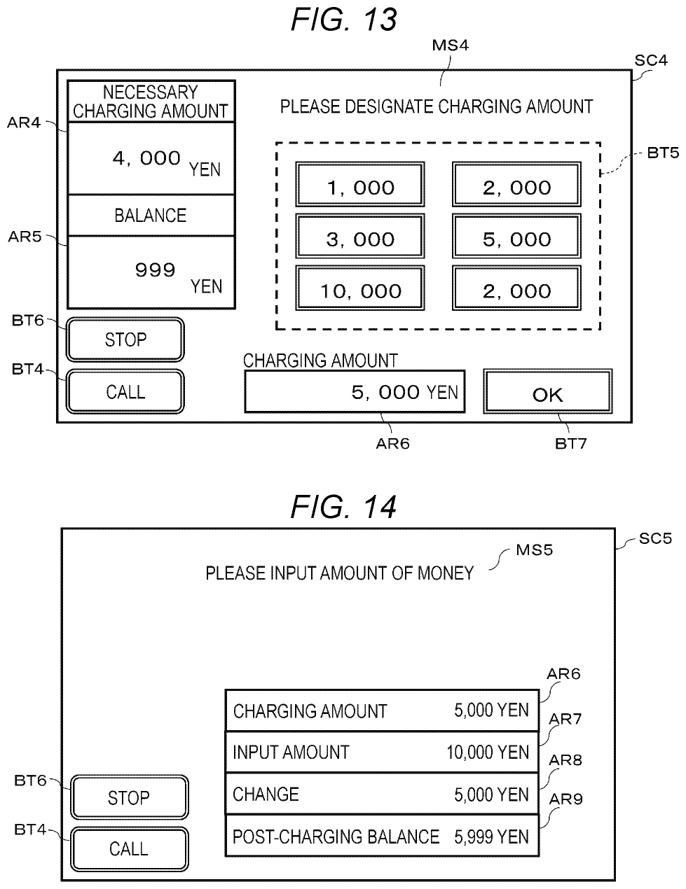

FIG. 13 shows an exemplary embodiment of the charging screen SC4 in which 5,000 yen is designated as the charging amount D wherein the necessary charging amount C on the charging screen SC4 is displayed as 4,000 yen in FIG. 12. Since the charging amount D is equal to or greater than the necessary charging amount C, the OK button BT7 is not grayed out to indicate an active state. The charging amount D is displayed in the charging amount area AR6.

The user checking that the OK button BT7 is in an active state touches the OK button BT7. The user cancels the charging by touching the stop button BT6 even if a charging amount has been designated.

In ACT31, the processor 12a validating the OK button BT7 checks whether the stop button BT6 is input. When the stop button BT6 is not input, the processor 12a determines NO in ACT31 and the process proceeds to ACT32. In ACT32, the processor 12a checks whether the OK button BT7 is input. When the OK button BT7 is not input, the processor 12a determines NO in ACT32 and the process returns to ACT31. Here, the processor 12a waits for an input of the stop button BT6 or an input of the OK button BT7 in ACT31 and ACT32.

When the processor 12a detects that the stop button BT6 is touched with a signal from the touch panel 12f in the waiting state of ACT31 and ACT32, the processor 12a determines YES in ACT31 and the process returns to ACT3 of FIG. 4. That is, the processor 12a returns the screen of the touch panel 12f from the charging screen SC4 to the payment method selection screen SC1. Then, the processor 12a waits for selection of any payment method.

When the processor 12a detects that the OK button BT7 is touched with a signal from the touch panel 12f in the waiting state of ACT31 and ACT32, the processor 12a determines YES in ACT32 and the process proceeds to ACT33. In ACT33, the processor 12a switches the screen of the touch panel 12f from the charging screen SC4 to a cash input screen SC5 (see FIG. 14).

FIG. 14 illustrates one display example of the cash input screen SC5. As illustrated in FIG. 14, a message MS5 prompting to input cash is displayed on the cash input screen SC5. A call button BT4, a stop button BT6, the charging amount area AR6, an input amount area AR7, a change area AR8, and a post-charging balance area AR9 are disposed on the cash input screen SC5. Although not illustrated, an illustration indicating a cash inputting operation is also displayed in a part of the cash input screen SC5. The input amount area AR7 is an area for displaying an amount of cash input to the change machine 12i. The change area AR8 is an area for displaying a change amount obtained from the input amount and the charging amount. The post-charging balance area AR9 is an area for displaying a balance of the electronic money after the charging amount is charged. In FIG. 14, amounts of money are displayed in the input amount area AR7, the change area AR8, and the post-charging balance area AR9, but the amounts of money are not displayed at the time point of ACT33.

The user checking the cash input screen SC5 inputs cash equivalent to the charging amount to the change machine 12i. However, when the user has no cash equivalent to the charging amount, the user touches the stop button BT6 to give an instruction to stop the charging.

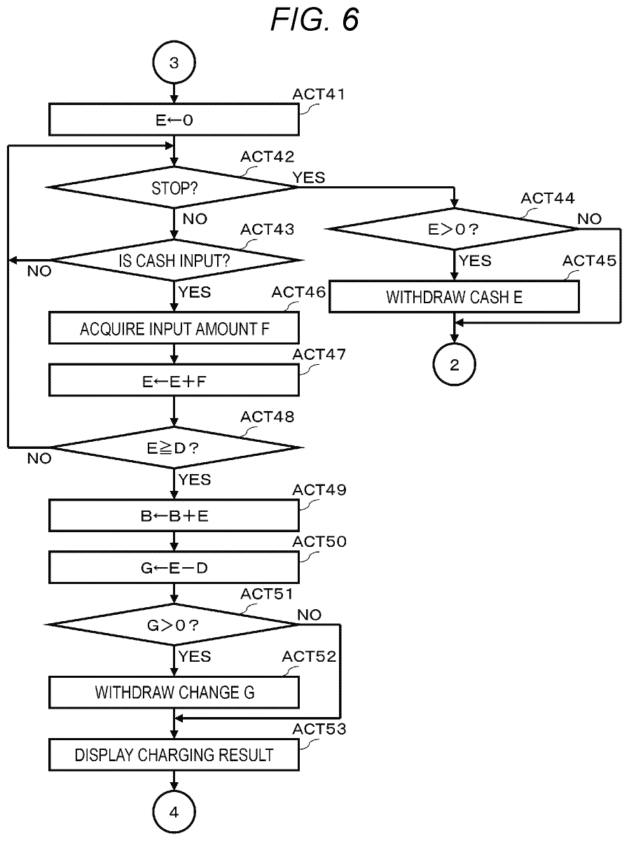

When the processor 12a displays the cash input screen SC5, the process proceeds to ACT41 of FIG. 6. The processor 12a clears an input memory E to “0” in ACT41. The input memory is formed in a volatile area of the main memory 12b.

In ACT42, the processor 12a checks whether the stop button BT6 is input. When the stop button BT6 is not input, the processor 12a determines NO in ACT42 and the process proceeds to ACT43. In ACT43, the processor 12a checks whether cash is input to the change machine 12i. When cash is not input, the processor 12a determines NO in ACT43 and the process returns to ACT42. Here, the processor 12a waits for an input of the stop button BT6 or an input of cash in ACT42 and ACT43.

When the processor 12a detects that the stop button BT6 is touched with a signal from the touch panel 12f in the waiting state of ACT42 and ACT43, the processor 12a determines YES in ACT42 and the process proceeds to ACT44. In ACT44, the processor 12a checks whether the value of the input memory E is greater than “0.” When the value of the input memory E is “0,” the processor 12a determines NO in ACT44 and the process returns to ACT3 of FIG. 4. Conversely, when the value of the input memory E is greater than “0,” the processor 12a determines YES in ACT44 and the process proceeds to ACT45. In ACT45, the processor 12a controls the change machine 12i such that an amount of money equivalent to the value of the input memory E is withdrawn. Thereafter, the processor 12a returns the process to ACT3 of FIG. 4. Thus, the processor 12a returns the screen of the touch panel 12f from the cash input screen SC5 to the payment method selection screen SC1. Then, the processor 12a waits for selection of any payment method.

When the processor 12a detects that cash is input with a signal from the change machine 12i in the waiting state of ACT42 and ACT43, the processor 12a determines YES in ACT43 and the process proceeds to ACT46. In ACT46, the processor 12a acquires an input amount F. Then, the processor 12a adds the input amount F to the input memory E in ACT47.

In ACT48, the processor 12a checks whether the value of the input memory E is equal to or greater than the charging amount D. When the value of the input memory E is not equal to or greater than the charging amount D, the processor 12a determines NO in ACT48 and the process returns to ACT42. That is, the processor 12a returns the process to the waiting state of ACT42 and ACT43. When the stop button BT6 is touched in the waiting state, the processor 12a determines YES in ACT44 and performs a process of ACT45. That is, the processor 12a performs control such that the cash input to the change machine 12i is withdrawn as it is and returns the screen of the touch panel 12f from the cash input screen SC5 to the payment method selection screen SC1.

When the value of the input memory E is equal to or greater than the charging amount D as a result of the input of the cash to the change machine 12i, the processor 12a determines YES in ACT48 and the process proceeds to ACT49. In ACT49, the processor 12a adds the value of the input memory E to the balance B acquired in the process of ACT8. In ACT50, the processor 12a calculates a change G by subtracting the charging amount D from the value of the input memory E.

In ACT51, the processor 12a checks whether the change G is greater than 0. When the change G is greater than 0, the processor 12a controls the change machine 12i in ACT52 such that the change G is withdrawn. Thereafter, the processor 12a causes the process to proceed to ACT53. When the change G is 0, the processor 12a determines NO in ACT51 and skips ACT52 to proceed to ACT53.

When the process proceeds to ACT53, the processor 12a displays a charging result on the cash input screen SC5 in ACT53. Specifically, as illustrated in FIG. 14, the processor 12a displays the value of the input memory E in the input amount area AR7, displays the change in the change area AR8, and displays the balance B after the addition of the value of the input memory E in the post-charging balance area AR9.

Thereafter, the processor 12a causes the process to proceed to ACT11 of FIG. 4. That is, the processor 12a updates the balance B stored in the main memory 12b to a value obtained by subtracting the payment amount A from the balance B. Then, the processor 12a performs an electronic money settlement process. When the settlement process ends, the processor 12a controls issuance of a receipt and switches the screen of the touch panel 12f from the cash input screen SC5 to the payment completion screen SC3.

The user checking the payment completion screen SC3 moves away from the settlement device 12 after the user receives a receipt. When the user moves away from the settlement device 12, the screen of the touch panel 12f returns to the initial screen. In this way, the processor 12a ends the information processing when the balance B of the electronic money is less than the payment amount A.

Next, a case in which the payment amount A exceeds the balance upper limit of the electronic money will be described.

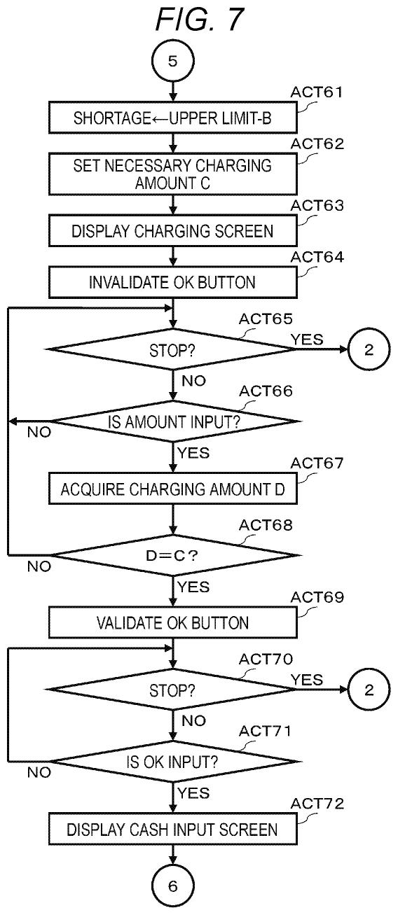

When the payment amount A exceeds the balance upper limit of the electronic money, the processor 12a determines NO in ACT9 and the process proceeds to ACT61 of FIG. 7. In ACT61, the processor 12a calculates a shortage of the balance B from the balance upper limit. That is, the processor 12a calculates an amount of money obtained by subtracting the balance B from the balance upper limit as the shortage.

When the shortage is calculated, the processor 12a sets the necessary charging amount C based on the shortage in ACT62, as in ACT22. Then, in ACT63, the processor 12a switches the screen of the touch panel 12f from the reading standby screen SC2 to the charging screen SC4. In ACT64, the processor 12a invalidates the OK button BT7.

Even in this case, the user operates the charging button BT5 to designate the charging amount equal to or greater than the necessary charging amount C. However, for example, when the user does not have cash equal to or greater than the necessary charging amount C, the user touches the stop button BT6 to give an instruction to stop the charging.

In ACT65, the processor 12a invalidating the OK button BT7 checks whether the stop button BT6 is input. When the stop button BT6 is not input, the processor 12a determines NO in ACT65 and the process proceeds to ACT66. In ACT66, the processor 12a checks whether the charging amount is designated. When the charging amount is not designated, the processor 12a determines NO in ACT66 and the process returns to ACT65. Here, the processor 12a waits for an input of the stop button BT6 or designation of the charging amount in ACT65 and ACT66.

When the processor 12a detects that the stop button BT6 is touched with a signal from the touch panel 12f in the waiting state of ACT65 and ACT66, the processor 12a determines YES in ACT65 and the process returns to ACT3 of FIG. 4. That is, the processor 12a returns the screen of the touch panel 12f from the charging screen SC4 to the payment method selection screen SC1. Then, the processor 12a waits for selection of any payment method.

When the processor 12a detects that the charging amount is designated with the signal from the touch panel 12f in the waiting state of ACT65 and ACT66, the processor 12a determines YES in ACT66 and the process proceeds to ACT67. In ACT67, the processor 12a acquires a charging amount D as in ACT27.

The processor 12a acquiring the charging amount D and storing the charging amount D in the main memory 12b compares the charging amount D with the necessary charging amount C in ACT68. Then, the processor 12a checks whether the charging amount D is equal to the necessary charging amount C. When the charging amount D is not equal to the necessary charging amount C, the processor 12a determines NO in ACT68 and the process returns to ACT65. That is, the processor 12a discards the stored charging amount D and the process returns to the waiting state of ACT65 and ACT66.

When the charging amount D is equal to the necessary charging amount C, the processor 12a determines YES in ACT68 and the process proceeds to ACT69. The processor 12a validates the OK button BT7 of the charging screen SC4 in ACT69.

The user checking that the OK button BT7 is in an active state touches the OK button BT7. The user designating the charging amount but canceling the charging touches the stop button BT6.

In ACT70, the processor 12a validating the OK button BT7 checks whether the stop button BT6 is input. When the stop button BT6 is not input, the processor 12a determines NO in ACT70 and the process proceeds to ACT71. In ACT71, the processor 12a checks whether the OK button BT7 is input. When the OK button BT7 is not input, the processor 12a determines NO in ACT71 and the process returns to ACT70. Here, the processor 12a waits for an input of the stop button BT6 or an input of the OK button BT7 in ACT70 and ACT71.

When the processor 12a detects that the stop button BT6 is touched with a signal from the touch panel 12f in the waiting state of ACT70 and ACT71, the processor 12a determines YES in ACT70 and the process returns to ACT3 of FIG. 4. That is, the processor 12a returns the screen of the touch panel 12f from the charging screen SC4 to the payment method selection screen SC1. Then, the processor 12a waits for selection of any payment method.

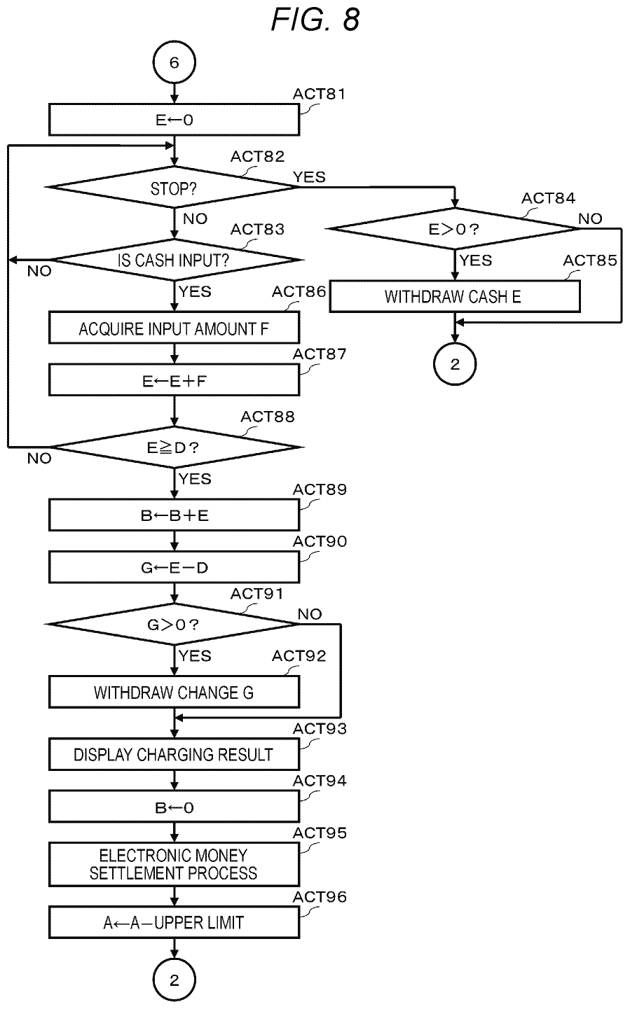

When the processor 12a detects that the OK button BT7 is touched with a signal from the touch panel 12f in the waiting state of ACT70 and ACT71, the processor 12a determines YES in ACT71 and the process proceeds to ACT72. In ACT72, the processor 12a switches the screen of the touch panel 12f from the charging screen SC4 to the cash input screen SC5 as in ACT33. Thereafter, the processor 12a causes the process to proceed to ACT81 of FIG. 8. In ACT81, the processor 12a clears the value of the input memory E to “0.”

When the process of ACT81 ends, the processor 12a performs the same process as the processes of ACT42 to ACT53 of FIG. 6 in ACT82 to ACT93. That is, the processor 12a waits for an input of the stop button BT6 or an input of charged cash in ACT82 and ACT83. When the stop button BT6 is touched, the processor 12a checks in ACT84 whether the value of the input memory E is greater than “0.” When the value of the input memory E is “0,” the processor 12a returns the process to ACT3 of FIG. 4.

Conversely, when the value of the input memory E is greater than “0,” the processor 12a controls the change machine 12i in ACT85 such that an amount of money equivalent to the value of the input memory E is withdrawn. Thereafter, the processor 12a returns the process to ACT3 of FIG. 4.

When the processor 12a detects that cash is input to the change machine 12i in the waiting state of ACT82 and ACT83, the processor 12a acquires an input amount F in ACT86. Then, the processor 12a adds the input amount F to the input memory E in ACT87. In ACT88, the processor 12a checks whether the value of the input memory E is equal to or greater than the charging amount D. When the value of the input memory E is not equal to or greater than the charging amount D, the processor 12a returns the process to the waiting state of ACT82 and ACT83.

When the value of the input memory E is equal to or greater than the charging amount D as a result of the input of the cash to the change machine 12i, the processor 12a adds the value of the input memory E to the balance B acquired in the process of ACT8 in ACT89. In ACT90, the processor 12a calculates the change G by subtracting the charging amount D from the value of the input memory E. Here, when the change G is greater than 0, the processor 12a controls the change machine 12i in ACT92 such that the change G is withdrawn. When the change G is 0, the processor 12a skips ACT92.

In ACT93, the processor 12a displays the charging result on the cash input screen SC5 as in ACT53. In ACT94, the processor 12a sets the balance B to “0.” Then, in ACT95, the processor 12a performs an electronic money settlement process as in ACT12 of FIG. 4.

When the electronic money settlement process ends, the processor 12a calculates the balance of the payment amount A in ACT96. That is, the processor 12a calculates an amount of money obtained by subtracting the balance upper limit from the payment amount A as a balance of the payment amount A. The processor 12a calculating the balance returns the process to ACT3 of FIG. 4. That is, the processor 12a returns the screen of the touch panel 12f from the charging screen SC4 to the payment method selection screen SC1. Then, the processor 12a waits for selection of any payment method except for electronic money.

Accordingly, when cash is selected as the payment method, the processor 12a performs a cash settlement process on the balance. When a credit card is selected as the payment method, the processor 12a performs a credit card settlement process on the balance.

As described above, the processor 12a ends the information processing when the payment amount A exceeds the balance upper limit of the electronic money.

As apparent from the above description, the settlement device 12 according to the embodiment serves as a payment amount acquisition unit by causing a computer using the processor 12a as a main unit to perform the processes of ACT1 and ACT2. That is, the computer acquires the payment amount A from the accounting data. The settlement device 12 serves as a balance acquisition unit by causing the computer to perform the processes of ACT1 and ACT8 in cooperation with the reader-writer 12h. That is, the computer acquires the balance B of the electronic money based on the data of the electronic money medium read by the reader-writer 12h. The settlement device 12 serves as a first settlement unit by causing the computer to perform the processes of ACT10 to ACT12. That is, when the balance B is equal to or greater than the payment amount A, the computer updates the balance B to an amount of money obtained by subtracting the payment amount A from the balance B and settles the transaction.

The settlement device 12 serves as a first notification unit by causing the computer to perform the process of ACT10 and the processes of ACT21 to ACT23 in cooperation with the touch panel 12f. That is, when the balance B is less than the payment amount A, the computer gives a notification of the necessary charging amount C set based on a shortage obtained by subtracting the balance B from the payment amount A in the charging screen SC4 displayed on the touch panel 12f. The settlement device 12 serves as an input unit by causing the computer to perform the processes of ACT41 to ACT48 in cooperation with the change machine 12i. That is, the computer receives an input of the charging amount for the electronic money by adding the amount of money of cash input to the change machine 12i to the input memory E. The settlement device 12 serves as a second settlement unit by causing the computer to perform the process of ACT49 and the processes of ACT11 and ACT12. That is, when the first notification unit gives the notification of the necessary charging amount C and the input unit receives the input of the amount of money equal to or greater than the necessary charging amount C, the computer updates the balance B to the amount of money obtained by subtracting the payment amount A from the amount of money obtained by adding the input amount of money to the balance B and settles a transaction.

In the settlement device 12 with the configuration, when the balance B of the electronic money is equal to or greater than the payment amount A, a transaction related to the payment amount can be settled only by causing merely the reader-writer 12h to read the data of the electronic money medium.

Conversely, when the balance B does not reach the payment amount A, the user of the electronic money is required to charge the electronic money until the balance B of electronic money becomes at least an amount of money necessary for payment. In the settlement device 12 with the configuration, the user is notified of the necessary charging amount C. Then, when the user charges an amount of money equal to or greater than the necessary charging amount C, the settlement device 12 performs the settlement process with the electronic money. Accordingly, the charging process may not consume unnecessary time since the user knows the necessary charging amount C. Therefore, it is possible to enhance process efficiency of the settlement device 12.

The settlement device 12 serves as a designation unit by causing the computer using the processor 12a as a main unit to perform the processes of ACT26 to ACT29 in cooperation with the touch panel 12f. That is, the computer receives an operation input of the charging button BT5 of the charging screen SC4 displayed on the touch panel 12f and designates the charging amount D. When the computer performs the processes of ACT24 and ACT30, the input unit receives an input of money under the condition that the designation unit designates the charging amount D equal to or greater than the necessary charging amount C.

In the settlement device 12 with the configuration, an unnecessary inputting process is not performed since the input unit does not receive the input of money when the charging amount D less than the necessary charging amount C is designated. Accordingly, it is possible to enhance the process efficiency of the settlement device 12.

The designation unit is configured to designate, as the charging amount, the amount of money allocated to any amount button selected on the charging screen SC4 on which a plurality of amount buttons to which different amounts of money are allocated are disposed. The first notification unit displays the necessary charging amount C in a part of the charging screen SC4 for notification. Therefore, since the user can designate the charging amount D while viewing the necessary charging amount C, the user can easily designate a charging amount equal to or greater than the necessary charging amount C. Accordingly, it is also possible to enhance the process efficiency of the settlement device 12.

In the settlement device 12, the OK button BT7, which is an operation button for giving an instruction to confirm the charging amount, is disposed on the charging screen SC4. The designation unit permits an input of the OK button BT7 under the condition that the charging amount D equal to or greater than the necessary charging amount C is designated. The input unit receives the input of money in response to the input OK button BT7. Accordingly, the settlement device 12 does not receive the input of the OK button BT7 until the charging amount D equal to or greater than the necessary charging amount C is designated. Thus, it is further possible to enhance the process efficiency of the settlement device 12.

The settlement device 12 serves as a second notification unit by causing the computer that uses the processor 12a as a main unit to perform the process of ACT4 and the processes of ACT61 to ACT63 in cooperation with the touch panel 12f. That is, when the payment amount A exceeds the balance upper limit of the electronic money, the computer gives the notification of the necessary charging amount C set based on an amount of money obtained by subtracting the balance B from the balance upper limit in the charging screen SC4 displayed on the touch panel 12f. The computer serves as a third settlement unit by performing the processes of ACT81 to ACT96 and the processes of ACT3 to ACT5 in cooperation with the change machine 12i. That is, the computer updates the balance B to zero and settles a transaction on a balance obtained by subtracting the balance upper limit from the payment amount A by a method other than the electronic money when the second notification unit gives the notification of the necessary charging amount C and the input unit receives an input of money equal to or greater than the necessary charging amount C.

Since the settlement device 12 further has the foregoing configuration, when the payment amount A exceeds the balance upper limit of the electronic money, it is possible to reliably perform an operation of making payment with the electronic money until the balance upper limit of the electronic money is reached, then paying the remaining amount by a payment method other than electronic money. Accordingly, even when the payment amount A exceeds the balance upper limit of the electronic money, it is possible to process settlement quickly without deteriorating the process efficiency of the settlement device 12.

The embodiment of the settlement device in which the user of the electronic money easily ascertains the charging amount necessary for payment is described above. However, the embodiment is not limited thereto.

In some embodiments, the user is notified of the necessary charging amount C by displaying the necessary charging amount C in the charging screen SC4 displayed on the touch panel 12f. The notification unit for the necessary charging amount C is not limited to a display. For example, when the settlement device 12 includes a sound combination device, the user may be notified of the necessary charging amount C by sound.

In some embodiments, an amount of money obtained by rounding up the shortage in a unit equal to or less than a hundred yen is set as the necessary charging amount C. From this viewpoint, an amount of money obtained by adding an amount of money desired to remain as a balance after price payment to the amount of money obtained by rounding up the shortage in the unit equal to or less than a hundred yen may be set as the necessary charging amount C. For example, when the payment amount A is 4,000 yen, the balance B of the electronic money is 1,001 yen, and the user desires to leave 2,000 yen as a balance after the price payment, the necessary charging amount C is 5,000 yen. In this case, a balance of the electronic money after the price payment is 2,001 yen when the user charges 5,000 yen. Incidentally, an amount of money desired to remain as a balance after the price payment is preferably set in advance for each user. The amount of money desired to remain as the balance after the price payment may also be set uniformly.

In some embodiments, when the OK button BT7 is invalidated in ACT24 of FIG. 5, the charging amount D is equal to or greater than the necessary charging amount C in ACT28 and ACT29, and the amount of money obtained by adding the charging amount D to the balance B of the electronic money does not exceed the balance upper limit, the OK button BT7 is validated. Thus, the OK button BT7 may be normally validated. In this case, after the process of ACT49 of FIG. 6, the processor 12a checks whether the balance B after addition of the value of the input memory E is equal to or greater than the necessary charging amount C. When the balance B is equal to or greater than the necessary charging amount C, the processor 12a proceeds to ACT50. When the balance B does not reach the necessary charging amount C, the processor 12a returns the process to ACT23 and displays the charging screen SC4 again. In this way, the OK button BT7 is pressed and charged temporarily during an input of the amount of money. However, when the balance B does not reach the necessary charging amount C, the screen may return to the charging screen SC4 again.

In some embodiments, during the information processing when the payment amount A exceeds the balance upper limit of the electronic money, the electronic money is excluded from the payment method on the balance paid with the electronic money until the balance upper limit in the payment amount A. From the viewpoint, for example, when electronic money of a store-associated company and electronic money of other companies can be handled, a balance may be paid with the electronic money of the other companies.

In some embodiments, each unit included in the settlement device 12 may be included in the registration device 11 of the semi-self-service-type checkout system. A POS terminal of a POS system designed so that a salesclerk performs a process from registration to settlement of commodities may be included. Alternatively, a POS terminal which is a so-called self-register of a self-checkout system designed so that a customer performs a process from registration to settlement of commodities may be included. Incidentally, when the registration device 11 or the POS terminal includes each unit, a customer display is used to notify a user of a necessary charging amount or a touch panel is used to notify a salesclerk of a necessary charging amount.

In some embodiments of the settlement device 12, the designation unit may be omitted. When the user inputs an amount of money equal to or greater than the necessary charging amount, a balance of electronic money is equal to or greater than a payment amount. Accordingly, since a transaction can be settled, the settlement device 12 may not include the designation unit.

Similarly, by setting the balance upper limit to be infinite or not setting the balance upper limit, the settlement device 12 can exclude the second notification unit and the third settlement unit. When the balance upper limit is set to be infinite or is not set, the processor 12a normally determines YES in ACT9 and the information processing of the procedure indicated by the flowcharts of FIGS. 7 and 8 is not performed. Accordingly, the settlement device 12 may not include the second notification unit and the third settlement unit.

In the foregoing embodiment, the accounting data includes the commodity codes, the commodity names, the unit prices, the number of commodities, and the payment amount. The accounting data may include at least the commodity codes and the number of commodities. In this case, the settlement device 12 receiving accounting data queries a commodity database with a commodity code included in the accounting data to acquire the commodity names, the unit prices, and the like. Then, the settlement device 12 calculates a payment amount from the unit prices acquired from the commodity database and the number of commodities included in the accounting data.

The accounting data may include a transaction ID assigned for each transaction and may not include the commodity codes and the number of commodities. In this case, for example, the registration device 11 transmits the commodity codes and the number of commodities that a customer desires to purchase to a server via a LAN. The registration device 11 transmits the accounting data including the transaction ID to the settlement device 12. The settlement device 12 receiving the accounting data acquires the commodity codes and the number of commodities from the server by using the transaction ID included in the accounting data. The settlement device 12 queries a commodity database with the commodity code acquired from the server to acquire the commodity names, the unit prices, and the like. Then, the settlement device 12 calculates a payment amount from the unit prices acquired from the commodity database and the number of commodities acquired from the server.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A settlement device for settling a transaction for a customer purchasing at least one commodity, comprising:
a money input device configured to receive an input of money from a payment method; and
a processor configured to:
acquire a payment amount for the at least one commodity;
acquire a balance of electronic money associated with the customer;
when the balance is equal to or greater than the payment amount, settle the transaction by updating the balance by subtracting the payment amount from the balance;
when the balance is less than the payment amount,
generate a notification of a necessary charging amount set by subtracting the balance from the payment amount, and
responsive to the money input device receiving an input of money equal to or greater than the necessary charging amount, settle the transaction by updating the balance by adding the input amount of money and subtracting the payment amount.

2. The settlement device according to claim 1, further comprising:
a designation device configured to designate a charging amount,
wherein the money input device receives an input of money under a condition that the designation device designates a charging amount equal to or greater than the necessary charging amount.

3. The settlement device according to claim 2, further comprising a screen,
wherein the designation device is configured to designate, as the charging amount, an amount of money allocated to a selected one of a plurality of amount buttons disposed on the screen, wherein different amounts of money are allocated to the plurality of amount buttons, and the notification of the necessary charging amount is displayed on the screen.

4. The settlement device according to claim 3, wherein
an operation button is disposed on the screen and is configured to give an instruction to accept the charging amount, and the designation device permits the instruction from the operation button under a condition that the designated charging amount is equal to or greater than the necessary charging amount, and
the money input device receives the input of money in response to the instruction from the operation button.

5. The settlement device according to claim 1, wherein the processor is further configured to:
when the payment amount exceeds a balance upper limit of the electronic money,
generate a notification of a necessary charging amount set as a difference between the balance upper limit and the payment amount, and
responsive to the money input device receiving an input of money equal to or greater than the necessary charging amount, settle the transaction by adding the input amount of money to the balance upper limit and subtracting the payment amount.

6. The settlement device according to claim 1, wherein the payment method is one of cash, credit card, or in-store credit.

7. A method for settling a transaction for a customer purchasing at least one commodity, the method comprising:
acquiring a payment amount for the at least one commodity;
acquiring a balance of electronic money associated with the customer;
when the balance is equal to or greater than the payment amount, settling the transaction by updating the balance by subtracting the payment amount from the balance;
when the balance is less than the payment amount,
generating a notification of a necessary charging amount set by subtracting the balance from the payment amount,
receiving an input of money from a payment method, and
responsive to receiving an input of money that is equal to or greater than the necessary charging amount, settling the transaction by updating the balance by adding the input amount of money and subtracting the payment amount.

8. The method according to claim 7, further comprising:
designating a charging amount; and
receiving an input of money under a condition that the designated charging amount is equal to or greater than the necessary charging amount.

9. The method according to claim 8,
wherein designating the charging amount comprises selecting one of a plurality of amount buttons disposed on a screen, wherein different amounts of money are allocated to the plurality of amount buttons,
further comprising displaying on the screen the notification of the necessary charging amount.

10. The method according to claim 9, further comprising:
giving an instruction to accept the charging amount via an operation button disposed on the screen;
permitting the instruction from the operation button under a condition that the designated charging amount is equal to or greater than the necessary charging amount; and
receiving the input of money in response to the instruction from the operation button.

11. The method according to claim 7, further comprising:
when the payment amount exceeds a balance upper limit of the electronic money,
generating a notification of a necessary charging amount set as a difference between the balance upper limit and the payment amount, and
responsive to receiving an input of money from a payment method equal to or greater than the necessary charging amount, settling the transaction by adding the input amount of money to the balance upper limit and subtracting the payment amount.

12. The method according to claim 7, wherein the payment method is one of cash, credit card, or in-store credit.
